(19) United States
(12) Patent Application Publication
(10) Pub. No.: US 2007/0033562 A1
(43) Pub. Date: Feb. 8, 2007

(54) Integrated circuit power distribution layout with sliding grids

(75) Inventors: Anthony Correale JR., Raleigh, NC (US); Douglass Thornton Lamb, Cary, NC (US)

Correspondence Address: DILLON & YUDELL LLP, 8911 N. CAPITAL OF TEXAS HWY.,, SUITE 2110, AUSTIN, TX, 78759, US

(73) Assignee: International Business Machines Corporation, Armonk, NY (US)

(21) Appl. No.: 11/198,591

(22) Filed: Aug. 5, 2005

(51) Int. Cl. G06F 17/50

(52) U.S. Cl. 716/10; 716/9

(57) ABSTRACT

A method and integrated circuit (IC) configuration/design that provides efficient layout of power distribution wires within the IC. The power busses of each IC layers are configured as moveable segments capable of being shifted away from the normal propagation path of the remainder of the power bus. Circuit elements are pre-wired in a dense configuration, and the location of the pre-wired circuit elements is not disturbed by placement of the power busses running parallel to the signal wires of the circuit elements because the power bus segments are placed in locations that are not overlapping with the signal wires of the circuit elements. Each row or column of circuits are placed independent of the adjacent row or column of circuits with regard to the meshed power distribution, since each row or column is capable of being independent of the other.

### BACKGROUND OF THE INVENTION

1. Technical Field

The present invention relates generally to integrated circuits and specifically to design configuration of integrated circuits. Still more particularly, the present invention relates to a method and design configuration for improved power distribution layout within integrated circuits to support enhanced circuit placement density.

2. Description of the Related Art

Power distribution on integrated circuits has resulted in significant wiring and cell placement contention in high frequency and high-capacity chip designs. The contentions for placement become more acute as power density increases (e.g., as more transistors are added with higher current per unit area), resistive power (“IR”) losses increases, and electromigration current thresholds decrease. Electromigration phenomenon is described in detail at http://www.csl.mete.metu.edu.tr/Electromigration/emig.htm.

Chip designers and electronic design automation tools typically implement a mesh of some fixed periodicity on each layer of manufactured metallurgy to distribute power uniformly across the die. The circuit library elements placed on the chip must share metal layers with the power distribution wires, resulting in resource contention. A fixed mesh power distribution may require circuits placed underneath power busses to be displaced because of this contention, leading to potentially inefficient placement and/or (in the absence of efficient placement) suboptimal wiring.

Conventional power routing efforts have not focused on the metal-versus-circuit displacement tradeoffs necessary across a chip. This is particularly true in very dense designs like microprocessors, where meeting the performance requirement demands tightly packed, carefully placed groups of related logic elements. Additionally, as placement density deviates from 100%, the increased wiring length and thus, net capacitance increases.

The most common power distribution in both ASIC (Application Specific Integrated Circuit) and custom microprocessor designs is a mesh composed of alternating horizontal and vertical wires on each layer of chip metallurgy, with connections between the layers at the intersections. There is typically a local or global mesh for each power supply voltage and ground that must be serviced by each group of circuits. Power and signal wiring are generally oriented in the same direction, with alternating layers favoring one direction (horizontal or vertical) that is perpendicular to the layers above and below it. This configuration serves to minimize interlayer capacitance and to guarantee high metal availability when routing in two dimensions. Individual transistors in a circuit element are wired with the lowermost signal routing layers, and progressively larger and more complex groups of circuit elements are wired together adding progressively higher layers of metallurgy in the chip layer stack.

FIG. 1 depicts a prior art representation of a power mesh, where contention occurs between power and signal wiring resources on the lowermost vertical layer of chip metallurgy. The vertical stacks of circuit library elements 106 interconnected by pre-routed vertical signal wires 108 have been physically displaced to accommodate the fixed periodic power bus wire 104. Horizontal power bus wire 102 are provided to illustrate the power mesh but are not utilized to describe the displacement. The “vertical stacks” are pre-wired circuit macros that could, for example, represent individual bits of a register word, all of which receive the same clock or test signal wires. The layout illustrated by FIG. 1 is of a conventional circuit placement (of multiple circuit components, numbered 107, 109, 111, 113 and 115) and power distribution method used in the industry. Thus, as shown, the vertical power bus 104 remains unaltered (continuous), although one vertical power bus 104′ is illustrated as “broken” to demonstrate the need to displace circuit component 113. Also, with this configuration, as the physical size of the circuit(s) increases due to more complex functions, then the amount of displacement also increases. Finally, the amount of cell displacement is further exacerbated by cells having multiple pre-wired vertical signals 108 that happen to match the power bus stitch frequency.

In deep sub-micron technology, wiring capacitance is a higher proportion of the total net capacitance. Thus cell placements, which are perturbed due to inflexible meshed power distributions, will result in higher overall power dissipations, not only due to the increased wire length, but also due to the need to increase transistor sizes to compensate for the higher load. This further exacerbates the power bussing mesh needs as the power has now increased.

Prior art approaches include, for example: removing any dynamically inserted periodic power strap that conflicts with placement of logic elements by introducing additional meshing on their metal layers to compensate (U.S. Pat. No. 6,308,307) and removing power segments completely (U.S. Pat. No. 4,811,237). However, none of the prior art methods directly address the above problems of inefficiency with placement of power busses relative to logic elements on the die.

### SUMMARY OF THE INVENTION

Disclosed is a method and integrated circuit (IC) configuration/design that provides efficient layout of power distribution wires within the IC. A meshed power distribution configuration is provided/created in which the overall mesh is constructed of multiple ladders-like segments, with each ladder capable of being displaced from the other ladders to preserve the electrical integrity of the overall distribution, while achieving the densest cell placement. The power busses of each IC layer are configured as moveable segments capable of being shifted away from the normal propagation path of the remainder of the power bus. Circuit elements are pre-wired in a dense configuration, and the location of the pre-wired circuit elements is not disturbed by placement of the power busses running parallel to the signal wires of the circuit elements because the power bus segments are placed in locations that are not overlapping with the signal wires of the circuit elements. Each row or column of circuits are placed independent of the adjacent row or column of circuits with regard to the meshed power distribution, since each row or column is capable of being independent of the other.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 illustrates a traditional power mesh with circuit displacement according to the prior art;

FIG. 2A illustrates a variable power ladder with no circuit displacement according to one embodiment of the invention;

FIG. 2B illustrates an offset variable power ladder with no circuit displacement according to one embodiment of the invention;

FIG. 3 illustrates an exemplary offset variable power ladder according to one embodiment of the invention;

FIG. 4 illustrates two layers of a generalized variable power mesh according to one embodiment of the invention;

FIG. 5 illustrates a derivative variable power mesh with displacement for transistor power density in accordance with one embodiment of the invention;

FIG. 6 is a block diagram illustrating a general data processing system that may advantageously be utilized to perform the placement and sliding calculations for generating/designing an IC with the sliding power ladder configuration according to embodiments of the invention; and

FIG. 7 is a flow chart illustrating one embodiment of the processes undertaken to determine the power distribution configuration within an IC design.

### DETAILED DESCRIPTION OF AN ILLUSTRATIVE EMBODIMENT

The illustrative embodiments of the present invention provide a method and integrated circuit (IC) configuration/design that provides efficient layout of power distribution wires within the IC. A meshed power distribution configuration is provided/created in which the overall mesh is constructed of multiple ladders-like segments, with each ladder capable of being displaced from the other ladders to preserve the electrical integrity of the overall distribution, while achieving the densest cell placement. The power busses of each IC layers are configured as moveable segments capable of being shifted away from the normal propagation path of the remainder of the power bus. Circuit elements are pre-wired in a dense configuration, and the location of the pre-wired circuit elements is not disturbed by placement of the power busses running parallel to the signal wires of the circuit elements because the power bus segments are placed in locations that are not overlapping with the signal wires of the circuit elements. Each row or column of circuits are placed independent of the adjacent row or column of circuits with regard to the meshed power distribution, since each row or column is capable of being independent of the other.

The illustrative embodiments allow coarse adjustment of steps in the power distribution mesh to avoid the metallurgy of pre-routed signal wires in the underlying circuit library elements, without requiring displacement of those elements. The embodiments consider the placed structures and their input/output pin accessibility as having priority over the pattern of power distribution employed, within the power design constraints to be guaranteed by the distribution. In an alternate embodiment the input/output pin accessibility of the placed structures has priority over the pattern of power distribution employed, within the power design constraints to be guaranteed by the distribution. In still another embodiment, any combination of pre-routed signal wires and input/output pin accessibility has priority over the pattern of power distribution employed, within the power design constraints to be guaranteed by the distribution. Thus, a net effect is that illustrative embodiments enable a higher placement density and potentially higher performance, lower power design than conventional methods.

The embodiments also provide a procedure for designing the power distribution based on the above schemes. The procedure involves a heuristic approach that utilizes input data similar to those available to existing electronic design automation tools. Using heuristic programming methods, the IC is constructed with a variable power mesh having sliding grid lines or rungs. The power mesh is handled as an array of ladders placed next to each other. According to the invention, the integrity of the mesh power distribution is not changed if individual ladders are moved parallel to one another (i.e., changes to the integrity of the mesh power distribution is only affected if individual rungs of one of the ladders are moved further apart relative to one another). The techniques provided by the procedure ultimately result in increased placement density, which yields smaller circuit area, shorter wiring, higher performance, and lower power consumption. These benefits are achieved while preserving robust electromigration and resistive loss (“IR”) mitigation.

Description of the invention below is provided in various sections delineated by sequential letters of the alphabet (e.g., A, B, C). The order of presentation is however not relevant to the inventive concepts described and not meant to be construed as relevant to a best mode or other presentation. Further, it is understood that figures and associated descriptions only describe the power mesh and/or power ladders over two or three layers within the multilayered IC. The features described are however applicable to each pair of layers of the IC, and the IC may be designed in any one of a number of different designs having multiple layers and power distributed via a power mesh.

A. Variable Displacement of Ladders within Power Mesh

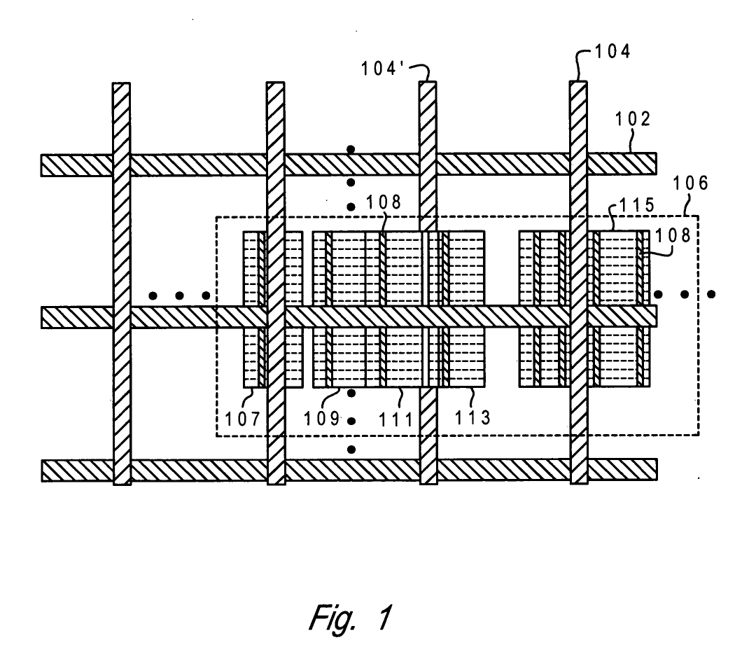

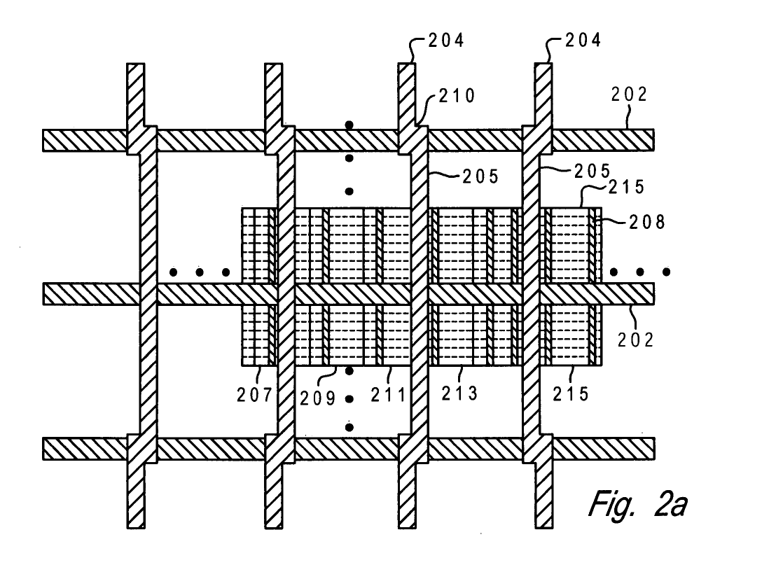

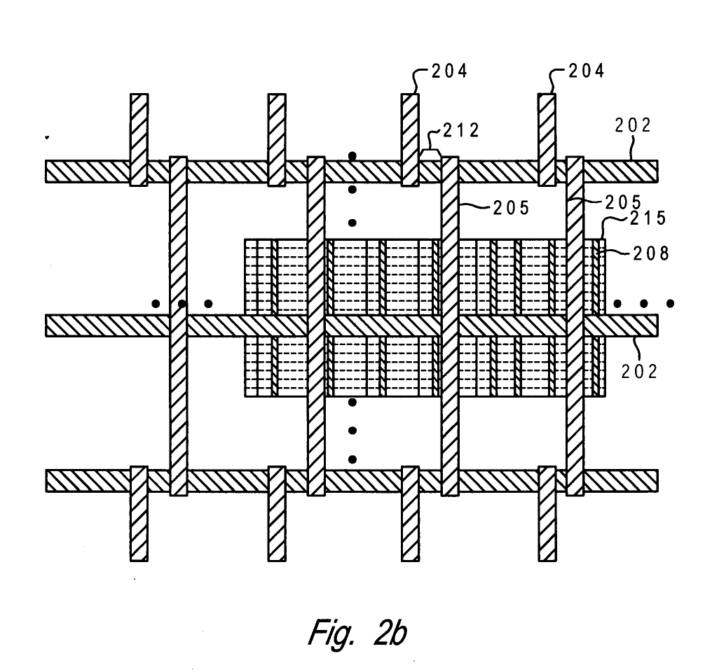

Referring now to the figures, FIG. 2A depicts displacement of individual ladders of the power mesh to accommodate placement of the pre-wired vertical circuit stacks (i.e., circuit elements/components, numbered 207, 209, 211, 213 and 215). With the methods of the illustrative embodiment, there is no need to displace the circuit elements 207-215 (i.e., no space is required between adjacent circuit elements due to placement of power lines), and thus, the circuit placement is denser than in conventional circuit designs (compare with FIG. 1, for example). As illustrated in FIG. 2A, each ladder comprises adjacent horizontal wires 202, with the perpendicular (displaced) vertical wires 205 that bridge any two horizontal wires 202 providing the rungs of the ladder. Vertical power wires 204 are broken across the horizontal wires to create/generate these rungs (displaced vertical wires 205).

Rather than displacing the entire power bus 204, where new resource contention might be introduced in groups of circuit elements vertically above or below the ones depicted, the power bus 204 is broken into segments (displaced vertical wires 205) at the points of overlap 210 between adjacent perpendicular metal layers in the chip layer stack. While this constrains global signal routing resources that may cross boundaries vertically between groups of circuit elements, it frees up signal wiring resources locally. Preserving the lowermost vertical power bus wire periodicity (and metal density) also helps ensure adequate protection against electromigration as well as noise and performance degradation caused by resistive voltage losses.

With the above configuration, a “sliding” rung approach to IC configuration is realized. The sliding rung approach involves displacing or sliding the rungs of one group or section of the power distribution wires at one layer. In the illustrative embodiment, the group/section of power distribution wires are displaced/slid an integer number of vertical tracks to create a void in the vertical continuity of the power bus. This void allows global signal routing resources that may cross boundaries vertically between groups of circuits to be unconstrained. In one embodiment, the void also allows improved access to wiring pin targets of circuit elements, where necessary.

FIG. 2B illustrates a similarly variable power ladder configuration with an additional offset 212. The L-shaped vertical bend, noted at 210 of FIG. 2A, is eliminated, as is illustrated at 212 in FIG. 2B, thereby allowing any vertical signal routing to pass through the 212 region unconstrained. The connectivity of the power distribution is preserved by means of connection to the higher-level (or lower-level) horizontal power buses. Overall, the pitch between vertical rungs on the ladder remains a constant and the electrical integrity of the power distribution is preserved without loss of placement density or global routing and/or pin access.

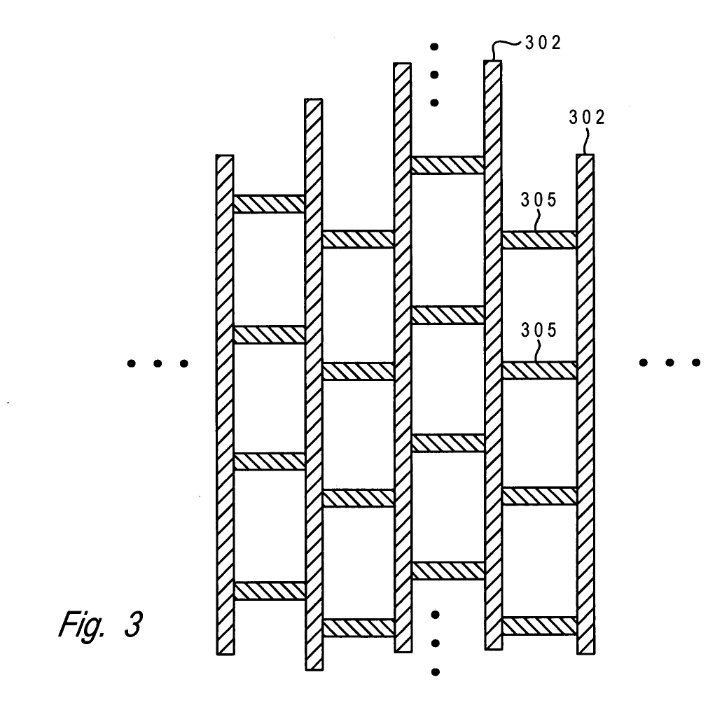

Turning now to FIG. 3, there is further illustrated the concepts of a sliding ladder approach to fixed periodicity power bus meshes. As illustrated, the power bus comprises a collection of ladder-like structures (i.e., visually presented with characteristics similar to a physical ladder) each sharing a common main rail. Each ladder comprises an adjacent set of vertical power buses 302 bridged by multiple horizontal rungs 305. In one embodiment, the adjacent set of vertical power buses 302 may be located on different layers of the IC (e.g., layers 1 and 3). In the illustrative embodiment, the ladder is depicted with a set of associated rungs 305 (power wires on a next layer) running at an angle (illustrated as perpendicular, but not necessarily so) to the vertical sides 302 of the ladder. According to the illustrative embodiment, the rungs 305 of each ladder are independent (as a group/set) and are not locked in place relative to the rungs 305 of other ladders. Each ladder may comprise multiple horizontal rungs 305 that span multiple bits or circuit row placements. Also, each ladder can be slid or moved up or down relative to an adjacent ladder to effect improved cell placement, without degradation to the overall power distribution.

Notably, for the purposes of this illustration, the underlying circuitry has not been shown so as to simplify the diagram. Also, in order to make the illustration more analogous to a real physical ladder, the rungs are shown horizontal and the main rails vertical. However, it is understood that the configuration/layout of the rungs relative to the main rails may be any orientation on any number of metal layers.

B. Constant Pitch for Rungs in all Ladders

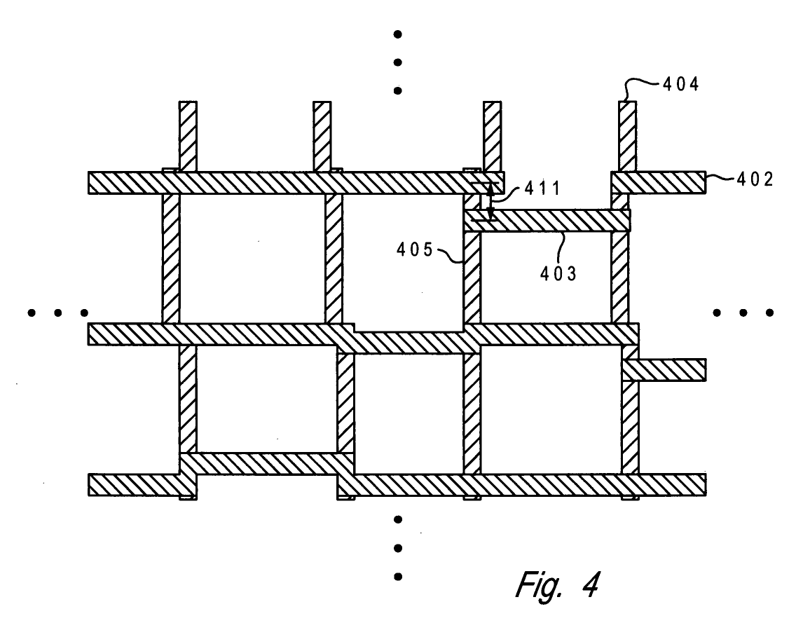

FIG. 4 depicts two layers of a power mesh with multiple displaced grid segments on various different layers of chip metallurgy. An optimal grid arrangement has the minimum horizontal segments 402 contending with horizontal signal wiring resources within groups of circuit elements (not shown) and minimum vertical segments 404 contending with vertical signal wiring resources (not shown). The horizontal segments 402 are displaced within the grid/mesh to provide displaced horizontal segments 403, while the vertical segments 404 are likewise displaced within the grid to provide displaced vertical segments 405. The configuration of FIG. 4 follows the method provided in FIG. 2B.

During configuration, if the entire ladder (i.e., the sets of rungs looking at the mesh horizontally and/or vertically) cannot be shifted to accommodate the desired placement, then a determination is made to make use of the maximum displacement distance of a rung(s) in the ladder relative to the neighboring rungs. The rung spacing is typically determined by an evaluation of one or more of the maximum allowed power density, local transistor placement density, and switching frequencies. Therefore the same set of entities may be taken into account to allow for local displacement of rungs. Thus, circuit placement is affected only in cases where a power bus segment must be displaced by more than the maximum displacement limit to guarantee adequate power distribution in the design. However, even in such cases, placement may be preserved by employing local power distribution schemes, such as multiple thin segments replacing one larger rung or introducing additional local rungs with a lower periodicity while preserving the overall electrical integrity.

C. Derivatives of the Variable Grid Mesh Power Distribution

Conventional power routing tools attack special cases of power routing, such as resistive losses from pads at the boundary of the chip or localized “jogs” to mate with power isolation rings. However, one embodiment of the invention modifies the variable power mesh distribution scheme, described above, to provide other benefits. As placement density varies across a chip, power bus wire frequency (or wire width) can be increased in those areas that are most dense and decreased in those areas that are least dense. Electronic design automation software that performs random logic placement and signal routing typically uses an abbreviated representation of the circuit library elements to contain data volume and enhance tool performance. Switching characteristics of transistors in different circuit elements that may be placed adjacent to one another (and thus their power demands) are difficult to characterize, even when executing a dedicated application. Thus, one embodiment of the invention provides heuristic approaches to creating a variable (and, in some implementations, near-optimal) power distribution. This aspect of the invention involves implementation of the heuristic design software tool within a data processing system to correctly compute and configure an IC power mesh and circuit element placement and/or displacement.

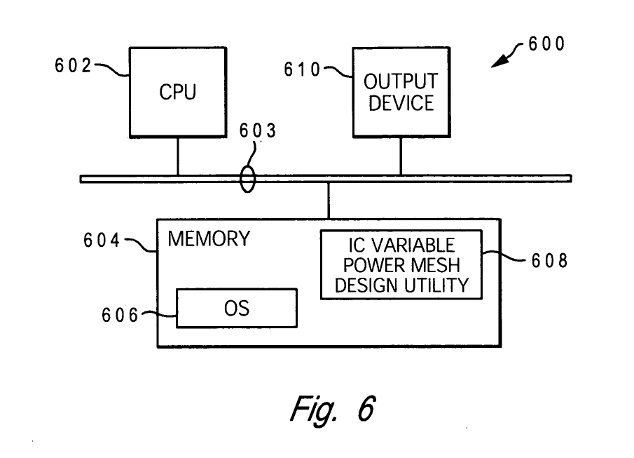

An exemplary data processing system within which the software features of the invention may be advantageously implemented is illustrated by FIG. 6. Basic configuration of data processing system 600 includes central processing unit (CPU) 602, coupled via system bus 603 to memory 604, within which an operating system (OS) 606 and an IC power mesh design utility 608 are stored for execution by CPU 602. Also, data processing system includes an output device 610 which may provide the desired output of a heuristic design modeling for creating an IC with optimal power and signal wiring.

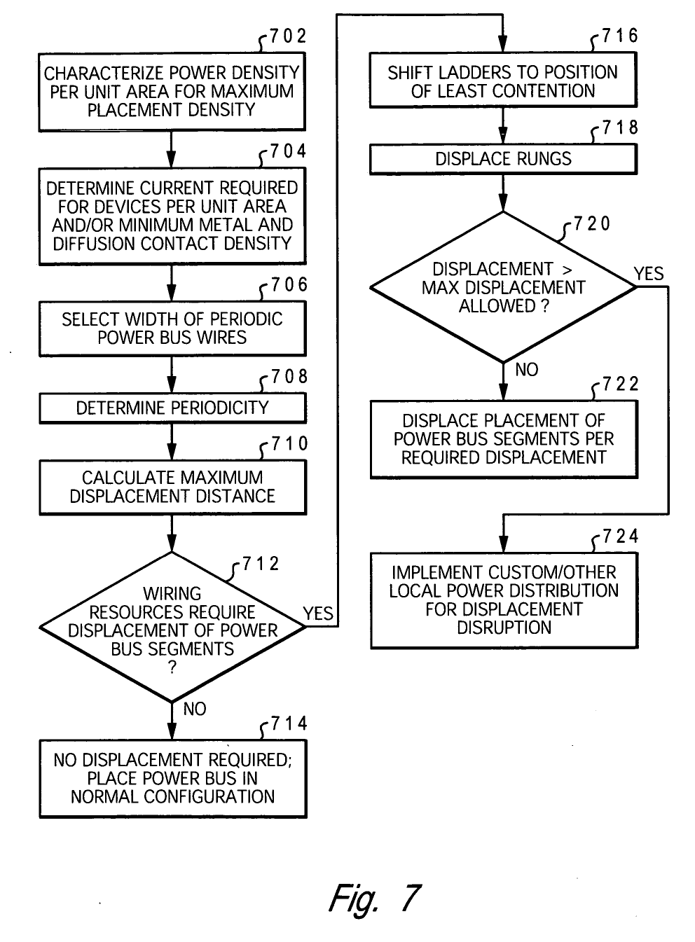

For simplicity of description, the IC power mesh design utility is described interchangeably as a heuristic utility and the single utility is assumed to carry out/provide the functions described below, as well as the process illustrated by FIG. 7. As an example of the operation, the heuristic utility utilizes circuit element size as a rough measure of transistor count, given the average transistor density of the circuit library. The utility is programmed to assume a switching factor for the number of transistors per circuit area that switch in a given unit of time, and the utility then estimates the power demand of a cell or group of cells using the above information. Following, the suitable metal width and periodicity combinations are computed and chosen from among various options, and the maximum displacement distance for the power grid segments is then calculated. Finally, the utility lays the grid segments over the circuits in such a way as to minimize contention with the required signal routing resources.

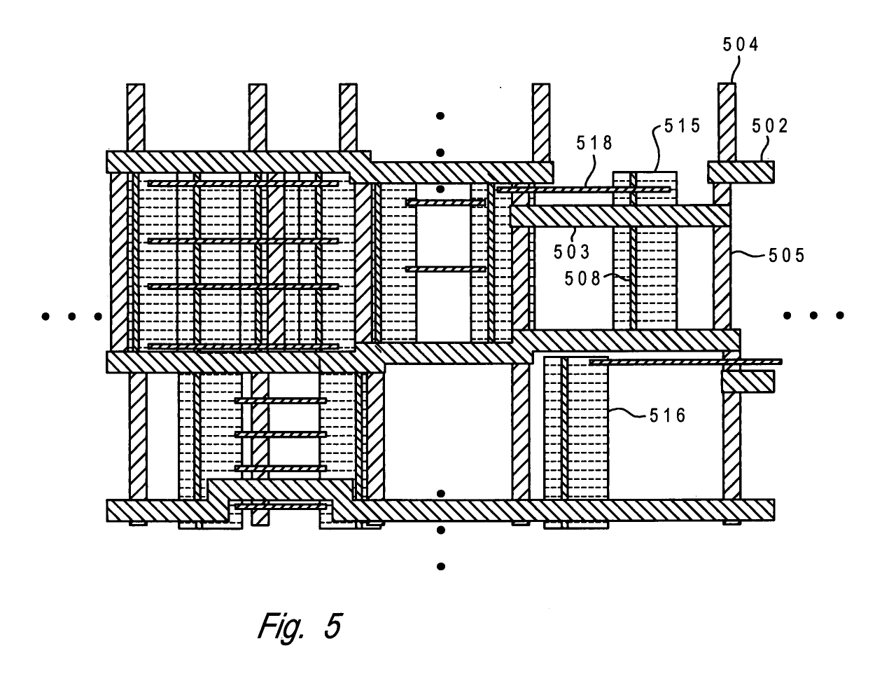

The latter step may move together power bus wires on layers having the same directionality, which is also useful for increasing the frequency of power strapping (i.e., tying together the two layers through the intermediate layer(s)) and thereby increasing the design margin or the maximum displacement distance of the power distribution network. The step of laying out the grid segments also biases higher layer power bus wires toward the perimeter of their local circuit groups where signal routing demand is not as high. A sample distribution, consistent with the above described method, is illustrated by FIG. 5. As shown, FIG. 5 provides many of the multi-directional sliding features provided by FIG. 4. However, FIG. 5 also illustrates the various circuit components (for example, components 515 and 516) distributed throughout the circuit and the sliding adjustments for both horizontal and vertical power meshes (502-503 and 504-505) based on routing of signal wires (518 and 508) within the respective circuit components. Additional metrics (other than circuit size or approximate transistor power) for optimizing the displacement of the mesh power segments are readily derivable by the heuristic utility. Also, the above described ladder approach may be applied to all wiring layers and all topological configurations.

D. Methodology—Application of the Variable Mesh Method

The flow chart of FIG. 7 illustrates one embodiment of the processes undertaken (by the utility, which may receive input from an IC circuit designer) to determine the power distribution configuration within an IC being designed. The process begins at block 702, at which the starting period of the power distribution mesh is determined by first characterizing the power density per unit area for a desired (maximum) placement density. In highly dense custom designs like microprocessor logic where placement density approaches 100%, the power density may approach the theoretical maximum defined by the technology ground rules on device gate or diffusion spacing and width. These ground rules essentially define the closest that current switching elements may be placed. Also, the poly (gate) and diffusion are utilized to create transistors.

The current required by the devices per unit area determines the minimum metal and diffusion contact density for the lowermost interconnection layer in the chip (block 704). The width of the periodic power bus wires is chosen (block 706) taking into consideration the desired signal wire widths and pitch, the electromigration reliability limits for the technology, and the IR losses desired. The periodicity is determined by the required metal density and width chosen (block 708). According to an alternate embodiment, if the power periodicity is determined by the design of the circuits being fed, then additional care is taken to provide at least the equivalent metal width (density) to power the circuits.

The introduction of higher layers of power metal in the chip layer stack provides less resistive paths to the nearest pads from which voltage is supplied. The resistance (and thus the voltage loss) decreases as more redundant mesh paths from the transistor connection point to the nearest power supply pads are added. Local switching behavior and placement density of the transistor devices and a choice of power wire widths that, for methodological reasons, may be somewhat greater than the minimum required, provide design margins and additional allowance for local power segment displacements, as described above. The maximum displacement distance is determined by calculating the point at which either electromigration limits or resistive losses within the local power distribution arrangement have reduced the power distribution confidence to an unacceptably low level (block 710). A determination is made (block 712) whether wiring resources used by the pre-wired group of circuit library elements would otherwise require displacement of the power bus segment(s). If not, then no displacement is required, and the power bus is placed in the normal configuration (block 714).

However, if displacement of the power bus segment(s) is required, the rungs of the ladders are shifted to a position of least contention (block 716), and the rungs are then displaced (block 718). Following, a determination is made (block 720) whether the displacement required is greater than the maximum displacement allowed. If not, then the power bus segments are displaced according to the required displacement within the maximum displacement (block 722). If, however, the required displacement is greater than the maximum displacement, then one of the localized, custom power displacement methods (described above) is implemented for providing the power distribution at that location with the least disruption (block 724). Among these localized, custom power displacement methods are (1) utilizing multiple thin segments replacing one larger rung and (2) introducing additional local rungs with a lower periodicity, while preserving the overall electrical integrity.

Another important attribute of the above described technique is that designers of more complex circuit functions are now able to employ higher levels of metallurgy in their realization without fear that the design will “break” the overall power distribution or radically restrict the circuit's placement. One example is that of a master-slave flip-flop where the clock connections may preferably be integrated within the cell on metal-2 (layer two of the IC) to ensure clock skew and overall integrity. With a fixed mesh distribution, this cell approach would be prohibited, as is the case of many other ASIC library functions and as such, design integrity may actually be compromised. With the power distribution features provided herein, the design integrity may be enhanced while having an adaptive power distribution scheme.

As a final matter, it is important that while an illustrative embodiment of the present invention has been, and will continue to be, described in the context of a fully functional computer system with installed management software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as floppy disks, hard disk drives, CD ROMs, and transmission type media such as digital and analog communication links.

While the invention has been particularly shown and described with reference to a preferred embodiment, it will be understood by those skilled in the art that various changes in form and detail may be made therein without departing from the spirit and scope of the invention. Thus, while the illustrative embodiments described orthogonal power buses with perpendicular (horizontal) rungs on vertical, side rails, those skilled in the art would appreciate that the invention may be implemented with rungs that are oriented at some other angle to the sides of the “ladder” other than a perpendicular angle (90 degrees). Further, the side rails of the ladders may themselves be oriented at some angle other than one which would be depicted as a true vertical or horizontal configuration.

What is claimed is:

1. In an integrated circuit (IC) design configuration, a method comprising:
determining a location of signal wires and pin targets associated with circuit elements within the IC; and
designing a power distribution mesh on top of the circuit elements, wherein segments of power busses running in the same direction as the signal wires are shifted away from placement above the signal wires and access points for the pin targets, such that substantially dense placement of the circuit elements is not disturbed to accommodate the power buses.

2. The method of claim 1, further comprising:
providing a power mesh having variable placement of segments of the power buses oriented in a first direction between adjacent parallel wires oriented in the orthogonal direction;
determining a spacing between each segment via evaluation of one or more of a plurality of factors, including: maximum allowed power density; local transistor placement density; IR loss; and switching frequencies.
adjusting a routing of segments of the power buses to avoid metallurgy of pre-routed signal wires in underlying circuit elements, such that minimal displacement of the underlying circuit elements occurs due to routing of the power buses.

3. The method of claim 1, further comprising:
pre-wiring said circuit elements with minimal spacing relative to each other to provide optimal density of IC design;
enabling adjustment of placement of individual segments of the power distribution mesh running in a first direction when the signal wires of the pre-wired circuit elements also run in that first direction.

4. The method of claim 1, wherein each segment provides a power bus oriented in a first direction between two adjacent orthogonal power buses on a next layer, and said method further comprises:
when the shifted segment of a power bus is not directly connected to a remaining portion of the power bus, enabling a continuous power connection between the shifted segment of the power bus and the remaining portion of the power bus via one of the two adjacent orthogonal power buses that delineates the shifted segment from the remaining portion of the power bus.

5. The method of claim 1, further comprising:
wherein each set of segments within first adjacent orthogonal power buses is shifted independent of a next set of segments between second adjacent orthogonal power buses;
deterministically shifting each segment in a direction along the axis of orientation of respective orthogonal power buses within which the set of segments is oriented to avoid placing each segment of the set of segments over a signal wire of the circuit element.

6. The method of claim 5, wherein the first and second adjacent orthogonal power buses are located on another layer of the IC than the power bus segments, and that another layer is situated above pre-wired circuit elements having signal wires running in a direction along the same directional axis as the direction of the adjacent orthogonal power buses, said method further comprising:
displacing segments within the adjacent orthogonal power buses relative to the direction of flow of the power buses at that another layer such that individual segments of the orthogonal power buses are not placed over the signal wires of the pre-wired circuit elements that are running in the same direction as the orthogonal power buses.

7. The method of claim 1, further comprising:
determining a maximum displacement limit for the power busses;
when the power bus placement resulting from shifting an entire set of segments is unable to provide desired placement, placing the segments of the power bus within the determined maximum displacement distance relative to each other; and
when placement of a power bus to avoid the signal wires requires displacement by more than the maximum displacement limit, completing one or more adjustments from among:
(1) adjusting placement of one or more circuit elements to enable use of some displacement within the maximum displacement limit;
(2) providing multiple thin power bus segments to replace a larger power segment; and
(3) introducing local power segments with a smaller periodicity than the original power segments.

8. The method of claim 1, further comprising:
determining a power demand for a cell or group of cells using the switching factor for the transistors per circuit area per unit of time;
determining a width of each power bus segment via analysis of (1) desired signal wire widths and pitch, (2) electromigration reliability limits, and (3) resistive power losses desired.
increasing power bus density in areas where placement density of the pre-wired circuit elements is greatest; and
decreasing power bus density where the placement density is less dense.

9. A computer program product comprising:
a computer readable medium; and
program code on the computer readable medium for configuring an integrated circuit (IC), said code comprising code for:
determining a location of signal wires and pin targets associated with circuit elements within the IC; and
designing a power distribution mesh on top of the circuit elements, wherein segments of power busses running in the same direction as the signal wires are shifted away from placement above the signal wires and access points for the pin targets, such that substantially dense placement of the circuit elements is not disturbed to accommodate the power buses.

10. The computer program product of claim 9, further comprising code for:
providing a power mesh having variable placement of segments of the power buses oriented in a first direction between adjacent parallel wires oriented in the orthogonal direction;
determining a spacing between each segment via evaluation of one or more of a plurality of factors, including: maximum allowed power density; local transistor placement density; IR loss; and switching frequencies;
adjusting a routing of segments of the power buses to avoid metallurgy of pre-routed signal wires in underlying circuit elements, such that minimal displacement of the underlying circuit elements occurs due to routing of the power buses.

11. The computer program product of claim 9, further comprising code for:
pre-wiring said circuit elements with minimal spacing relative to each other to provide optimal density of IC design;
enabling adjustment of placement of individual segments of the power distribution mesh running in a first direction when the signal wires of the pre-wired circuit elements also run in that first direction.

12. The computer program product of claim 9, wherein each segment provides a power bus oriented in a first direction between two adjacent orthogonal power buses on a next layer, and said program product further comprises code for:
when the shifted segment of a power bus is not directly connected to a remaining portion of the power bus, enabling a continuous power connection between the shifted segment of the power bus and the remaining portion of the power bus via one of the two adjacent orthogonal power buses that delineates the shifted segment from the remaining portion of the power bus.

13. The computer program product of claim 9, further comprising code for:
wherein each set of segments within a first adjacent orthogonal power buses is shifted independent of a next set of segments between second adjacent orthogonal power buses;
deterministically shifting each segment in a direction along the axis of orientation of respective orthogonal power buses within which the set of segments is oriented to avoid placing each segment of the set of segments over a signal wire or pin target of the circuit element.

14. The computer program product of claim 13, wherein the first and second adjacent orthogonal power buses are located on another layer of the IC than the power bus segments, and that another layer is situated above pre-wired circuit elements having signal wires running in a direction along the same directional axis as the direction of the adjacent orthogonal power buses, said program code further comprising code for:
displacing segments within the adjacent orthogonal power buses relative to the direction of flow of the power buses at that another layer such that individual segments of the orthogonal power buses are not placed over the signal wires of the pre-wired circuit elements that are running in the same direction as the orthogonal power buses.

15. The computer program product of claim 9, further comprising code for:
determining a maximum displacement limit for the power busses;
when the power bus placement resulting from shifting an entire set of segments is unable to provide desired placement, placing the segments of the power bus within the determined maximum displacement distance relative to each other; and
when placement of a power bus to avoid the signal wires required displacement by more than the maximum displacement limit, completing one or more adjustments from among:
(1) adjusting placement of one or more circuit elements to enable use of some displacement within the maximum displacement limit;
(2) providing multiple thin power bus segments to replace a larger power segment; and
(3) introducing local power segments with lower periodicity than the larger power segments.

16. The computer program product of claim 9, further comprising code for:
determining a power demand for a cell or group of cells using the switching factor for the transistors per circuit area per unit of time;
determining a width of each power bus segment via analysis of (1) desired signal wire widths and pitch, (2) electromigration reliability limits, and (3) resistive power losses desired.
increasing power bus density in areas where placement density of the pre-wired circuit elements is greatest; and
decreasing power bus density where the placement density is less dense.

17. An integrated circuit (IC) comprising:
a power mesh distribution comprising a plurality of first power buses running in a first direction on a first layer and a plurality of second power buses running in a second, orthogonal direction on a second layer, wherein at least said first power buses may be segmented between adjacent pairs of the second, orthogonal power buses to create a ladder-like configuration;
one or more circuit elements (cells) having signal wires oriented in the first direction; and
placement logic that deterministically shifts one or more of the segments of the first power buses in the orthogonal direction to enable optimal cell placement, wherein one or more segments are shifted away from a normal propagation path of the first power bus to avoid being placed above the signal wires of the one or more cells placed within the IC.

18. The IC of claim 17, wherein:
said circuit elements are pre-wired with minimal spacing relative to each other to provide optimal density of IC design;
the segments are spaced in a configuration relative to each other, said space being one determined via evaluation of one or more of: maximum allowed power density; local transistor placement density; IR losses; and switching frequencies;
the segments of the power bus are placed at a pre-determined maximum displacement distance relative to each other, when the power bus placement by shifting an entire set of segments is unable to provide desired placement; and
when placement of a power bus to avoid the signal wires required displacement by more than the maximum displacement limit, one or more adjustments are provided from among:
(1) adjusting placement of one or more circuit elements to enable use of some displacement within the maximum displacement limit;
(2) providing multiple thin power bus segments to replace a larger power segment; and
(3) introducing local power segments with a lower periodicity than the original power segments.

19. The IC of claim 17, wherein further, segments within orthogonal power buses in a next layer of the IC are placed within that next layer in a configuration that individual segments of the orthogonal power buses are not placed over the signal wires of pre-wired circuit elements that are running in the same direction as the orthogonal power buses.

20. A computing device having an IC configured according to claim 17.
